(19) United States
(12) Patent Application Publication
(10) Pub. No.: US 2007/0109672 A1
(43) Pub. Date: May 17, 2007

(54) Adjusting device for a screen

(76) Inventor: Wen-Chi Lin, Chiung-Lin Hsiang (TW)

Correspondence Address: CHARLES E. BAXLEY, ESQ., 90 JOHN STREET, THIRD FLOOR, NEW YORK, NY, 10038, US

(21) Appl. No.: 11/454,672

(22) Filed: Jun. 17, 2006

(30) Foreign Application Priority Data
Nov. 16, 2005 (CN) 200520123085.9

(51) Int. Cl. G02B 7/02

(52) U.S. Cl. 359/819

(57) ABSTRACT

An adjusting device for a screen has a barrel, a pivotal device and at least one elastic element. The barrel has a frictional device formed on the barrel and an opening longitudinally defined in the barrel. The pivotal device has a shaft inserted into the barrel and a flat axially extending out from the shaft. The at least one elastic element is mounted on the pivotal device and contacts with the frictional device on the barrel. With the friction between the frictional device and the at least one elastic element, the shaft can be positioned in a desired angle.

### BACKGROUND OF THE INVENTION

1. Field of the Invention

The present invention relates to an adjusting device, and more particularly to an adjusting device which can modulate angle of a screen.

2. Description of the Related Art

Due to the progress of related technology of liquid crystal, liquid crystal screens are introduced into the market widely with the high demand for peripherals of the related products. A conventional adjusting device for a screen is one of the peripherals of the liquid crystal screen. However, the conventional adjusting device for a screen is not easy to install with a complex structure and a high cost.

Therefore, the invention provides an adjusting device for a screen to mitigate or obviate the aforementioned problems.

### SUMMARY OF THE INVENTION

The main objective of the present invention is to provide an adjusting device for a screen and that is easily installed and has a simple structure.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first preferred embodiment of an adjusting device for a screen in accordance with the present invention;

FIG. 2 is a perspective view of the first preferred embodiment of the adjusting device for a screen in FIG. 1;

FIG. 3 is an exploded perspective view of a second preferred embodiment of an adjusting device for a screen in accordance with the present invention;

FIG. 4 is an exploded perspective view of a third preferred embodiment of an adjusting device for a screen in accordance with the present invention;

FIG. 5 is a perspective view of the third preferred embodiment of the adjusting device for a screen in FIG. 4;

FIG. 6 is an exploded perspective view of a fourth preferred embodiment of an adjusting device for a screen in accordance with the present invention;

FIG. 7 is an exploded perspective view of a fifth preferred embodiment of an adjusting device for a screen in accordance with the present invention;

FIG. 8 is a perspective view of an adjusting device for a screen for a screen in accordance with the present invention being mounted with a coil spring;

FIG. 9 is an exploded perspective of a sixth preferred embodiment of an adjusting device for a screen in accordance with the present invention;

FIG. 10 is a side plan view of the adjusting device in FIG. 10; and

FIG. 11 is an exploded perspective of a seventh preferred embodiment of an adjusting device for a screen in accordance with the present invention.

### DETAILED DESCRIPTION OF THE PREFERRED EMBODIMENT

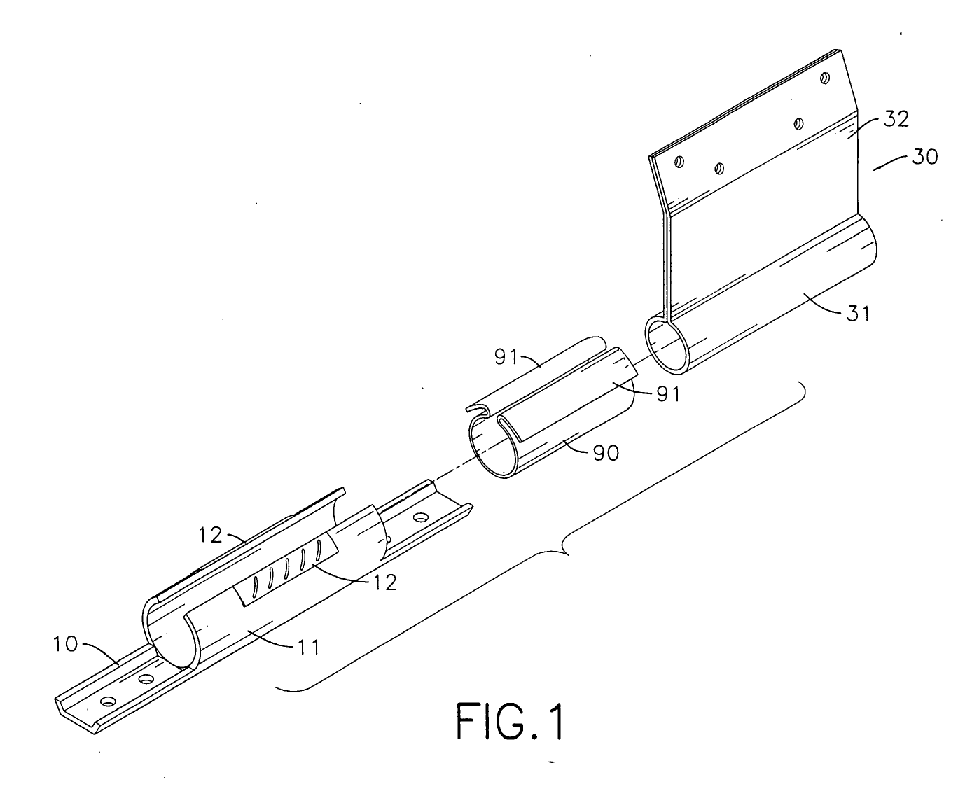

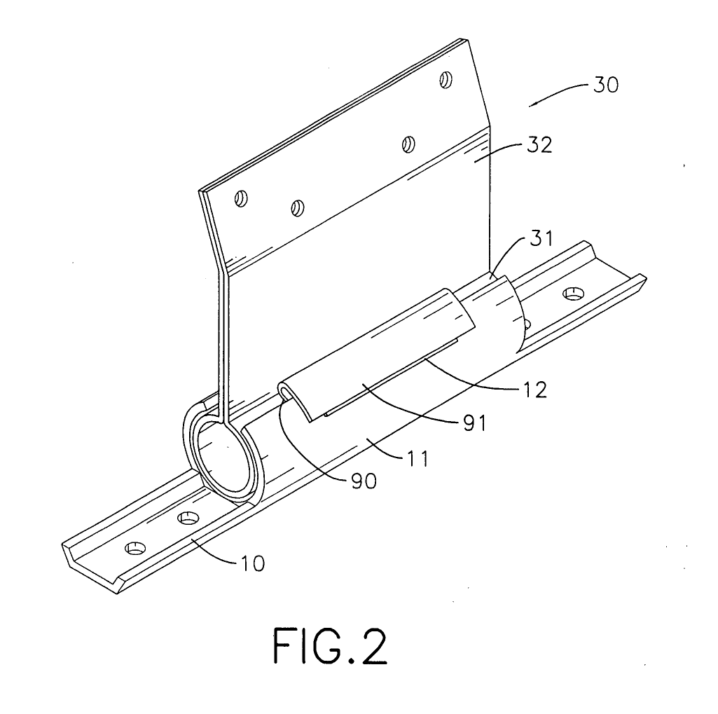

With reference to FIGS. 1-2, a first preferred embodiment of an adjusting device for a screen has a base (10), a pivotal element (30) and an outer cylinder (90).

The base (10) has a hollow barrel (11) formed in a middle portion thereof, and a first opening longitudinally defined in the barrel (11). The barrel (11) has a frictional device mounted on the barrel (11). In a preferred embodiment, the frictional device is two flanges (12) respectively formed on two sides of the first opening. Each flange (12) has at least one groove defined therein for oil storage.

The pivotal element (30) has a hollow shaft (31) and a flat (32) formed on and axially extending from the shaft (31).

The outer cylinder (90) has a second opening longitudinally defined therein and two elastic elements (91) respectively formed along two sides of the second opening and extending out from the outer cylinder (90).

In assembly, the shaft (31) is inserted into the outer cylinder (90) while the outer cylinder (90) is inserted into the barrel (11). The two elastic elements (91) respectively extend out of the first opening and contact with the flanges (12). The flat (32) extends out of the second opening.

In usage, the flat (32) is mounted on a screen so that the outer cylinder (90) with the shaft (31) is rotated in the barrel (11) when the screen is pivotally moved. When the forcing applied to the screen is released, the outer cylinder (90) with the shaft (31) can be positioned in a desired angle relative to the barrel (11) to position the screen via the friction force between elastic elements (91) on the outer cylinder (90) and the flanges (12) on the barrel (11).

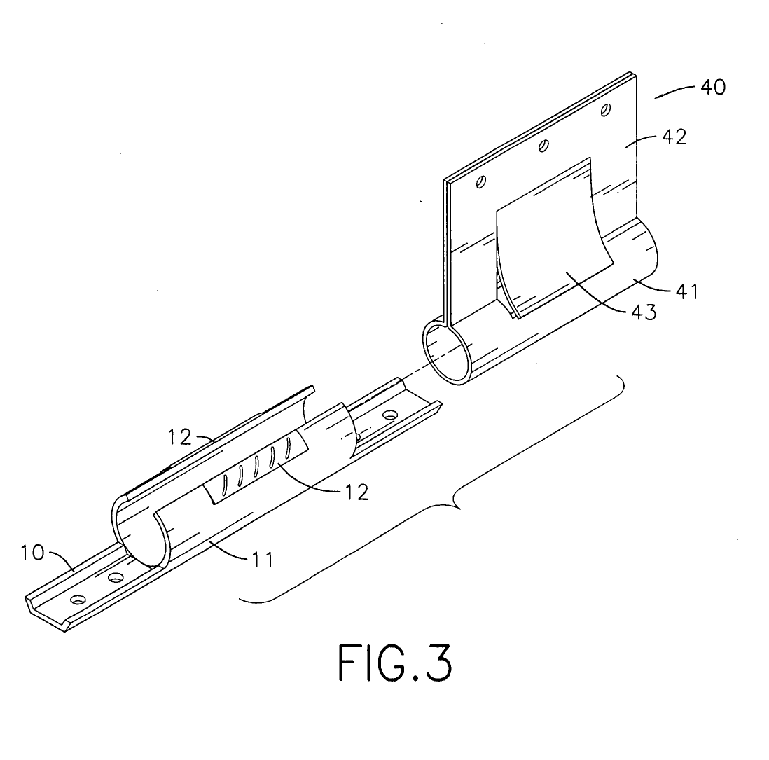

With reference to FIG. 3, a second preferred embodiment of an adjusting device for a screen has the base (10) with a structure same as that of the first embodiment, a pivotal element (40) and an optional bar. The pivotal element (40) has a hollow shaft (41) and a flat (42) axially extending out from the shaft (41). Two elastic elements (43) are respectively formed mounted on and extend downward from two sides of the flat (42). In a preferred embodiment, the elastic elements (43) are integrally formed on the flat (42) with a pressing process with a mold.

The bar is inserted into the shaft (41) to enhance the structural strength of the shaft (41).

In assembly, the shaft (41) is inserted into the barrel (11), and the flat (42) extends out of the first opening in the barrel (11) to make the elastic elements (43) contact with the flanges (12).

In usage, the flat (42) is mounted on a screen so that the shaft (41) is rotated in the barrel (11) when the screen is pivotally moved. When the force applied to the screen is released, the shaft (41) can be positioned in a desired angle to position the screen via the friction force between the elastic elements (43) and the flanges (12).

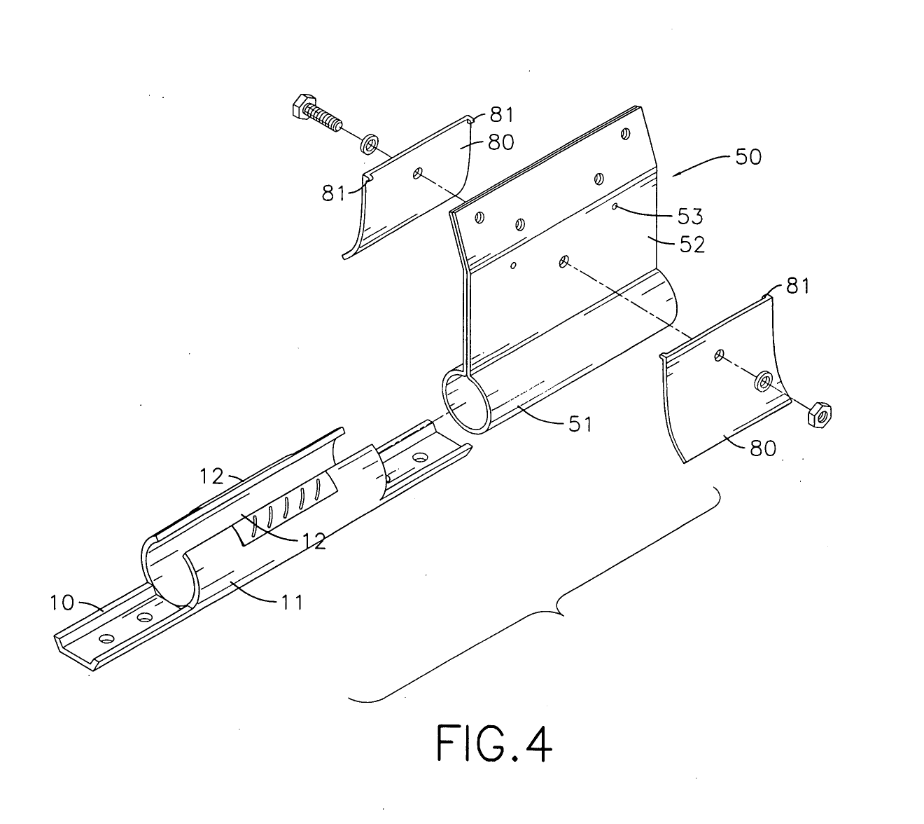

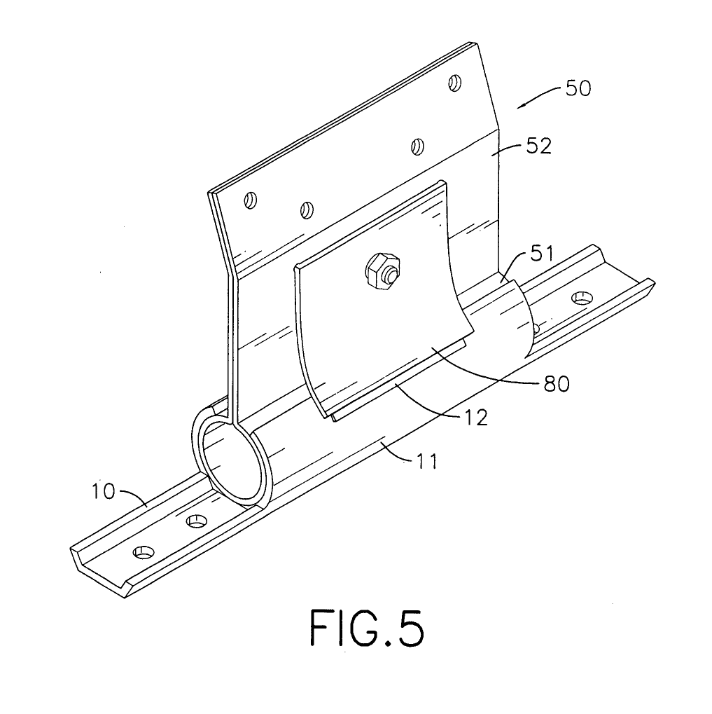

With reference to FIGS. 4 and 5, a third preferred embodiment of an adjusting device for a screen is similar to the second preferred embodiment except for a pivotal element (50).

The pivotal element (50) has a hollow shaft (51) and a flat (52) axially extending out from the shaft (51). Multiple holes (53) are respectively defined in the flat (52), and two elastic elements (80) are respectively mounted on two sides of the flat (42) with a fastener, such as a screw and a nut. The elastic elements (80) each have two lugs (81) formed in two edges thereof and engaged with the holes (53).

In usage, the elastic elements (80) respectively contact with the flanges (12), and the friction force between the flanges (12) and the elastic elements (80) can be changed by means of loosening or tightening the fastener. When the fastener is rotated, the tightness of combination between the elastic elements (80) and the flat (52) is changed such that the force applied to the flanges (12) from the elastic elements (80) is also changed. Accordingly, the friction force between the flanges (12) and the elastic elements (80) is changeable.

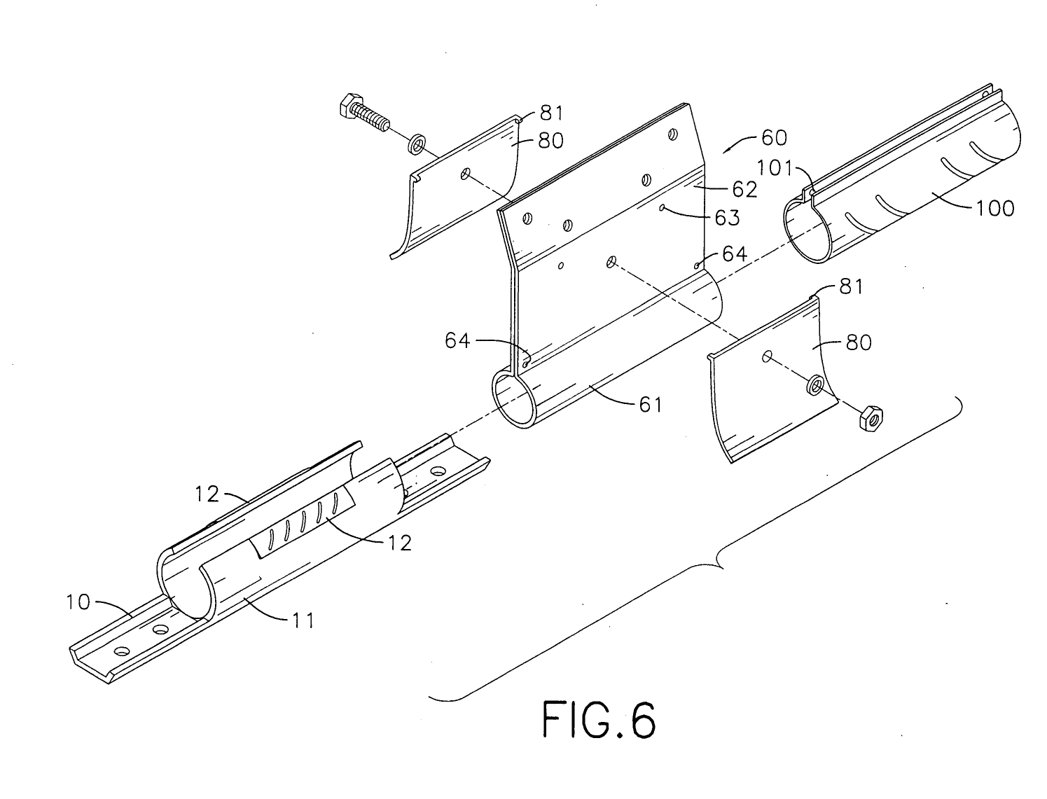

With reference to FIG. 6, a fourth preferred embodiment of an adjusting device for a screen is similar to the third preferred embodiment except for a pivotal element (60) and a tube (100).

The pivotal element (60) has a hollow shaft (61) and a flat (62) axially extending out from the shaft (61). Multiple holes (63) are respectively defined in the flat (62) and multiple openings (64) are respectively defined in a lower end of the flat (62). Two elastic elements (80) are respectively mounted two sides of the flat (62) with a fastener. The elastic elements (80) each have two lugs (81) formed in two edges thereof and engaged with the holes (63).

The tube (100) has two protrusions axially formed in an upper end thereof and parallel to each other. A gap is longitudinally defined between the protrusions and multiple tabs (101) are respectively formed in inner walls of the protrusions and engaged with the openings (64).

In assembly, the shaft (61) is inserted into the tube (100) while the tube (100) is inserted into the barrel (11). The elastic elements (80) are respectively contact with the flanges (12).

In usage, the flat (62) is mounted on a screen so that the shaft (61) and the tube (100) are respectively rotated in the barrel (11) when the screen is pivotally moved. When the force applied to the screen is released, the shaft (61) with the tube (100) can be positioned in a desired angle to position the screen with the friction force between the elastic elements (80) and the flanges (12). In addition, the friction force between the flanges (12) and the elastic elements (80) can also be changed by means of loosening or tightening the fastener.

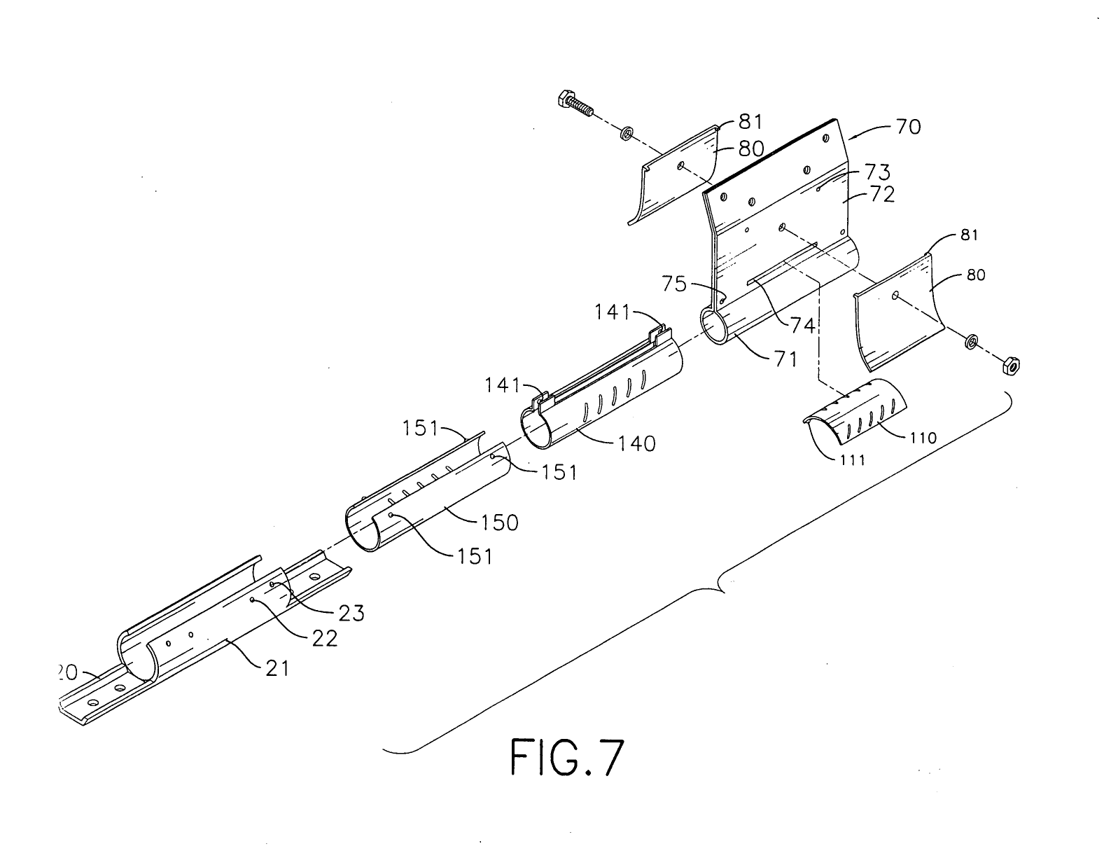

With reference to FIG. 7, a fifth preferred embodiment of an adjusting device for a screen has a base (20), a pivotal element (70), an outer cylinder (140), an inner cylinder (150) and an optional post.

The base (20) has a barrel (21) formed in a middle portion thereof, and an opening defined in the barrel (21). Multiple first orifices (22) and multiple second orifices (23) are respectively defined in the barrel (21) and adjacent to the opening.

The pivotal element (70) has a hollow shaft (71) and a flat (72) axially extending out from the shaft (71). Multiple holes (73) are respectively defined in the flat (72) and multiple openings (75) are respectively defined in a lower end of the flat (72). A slot (74) is laterally defined in the flat (72) and parallel to the shaft (71). Two elastic elements (80) are respectively mounted two sides of the flat (72) with a fastener. The elastic elements (80) each have two lugs (81) formed in two edges thereof and engaged with the holes (73).

The barrel (21) has a frictional device for providing friction to the elastic elements (80) on the shaft (71) to hold the shaft (71) in position. In an alternative embodiment, the frictional device is a fin (110) inserted into the slot (74) and mounted over the opening in the barrel (21). The fin (110) has multiple knobs (111) respectively engaged with the first orifices (22) to position the fin (110) to the barrel (21) and at least one groove for oil storage.

The hollow outer cylinder (140) has a first gap longitudinally defined therein and four ears respectively formed on two sides of the gap, and each ear has a first stub (141) formed in an inner wall thereof and perpendicular to the ear. Each first stub (141) is engaged with a corresponding opening (75).

The hollow inner cylinder (150) has a second gap longitudinally defined therein and four second stubs (151) formed in an inner wall thereof. Each second tab (151) is engaged with a corresponding second orifice (23).

The post is inserted into the shaft (71) to enhance the structural strength of the shaft (71).

In assembly, the shaft (71) is inserted into the outer cylinder (140), the outer cylinder (140) is inserted into the inner cylinder (150) and the inner cylinder (150) is inserted into the barrel (21) in turn. The flat (72) extends out of the opening in the barrel (21) to make elastic elements (80) contact with the fin (110).

In usage, the flat (72) is mounted on a screen so that the shaft (71) and the outer cylinder (150) are respectively rotated in the inner cylinder (140) when the screen is pivotally moved. When the force applied to the screen is released, the shaft (71) can be positioned in a desired angle to position the screen with the friction between the elastic elements (80) and the fin (110). The friction between the fin (110) and the elastic elements (80) can also be changed by means of loosening or tightening the fastener.

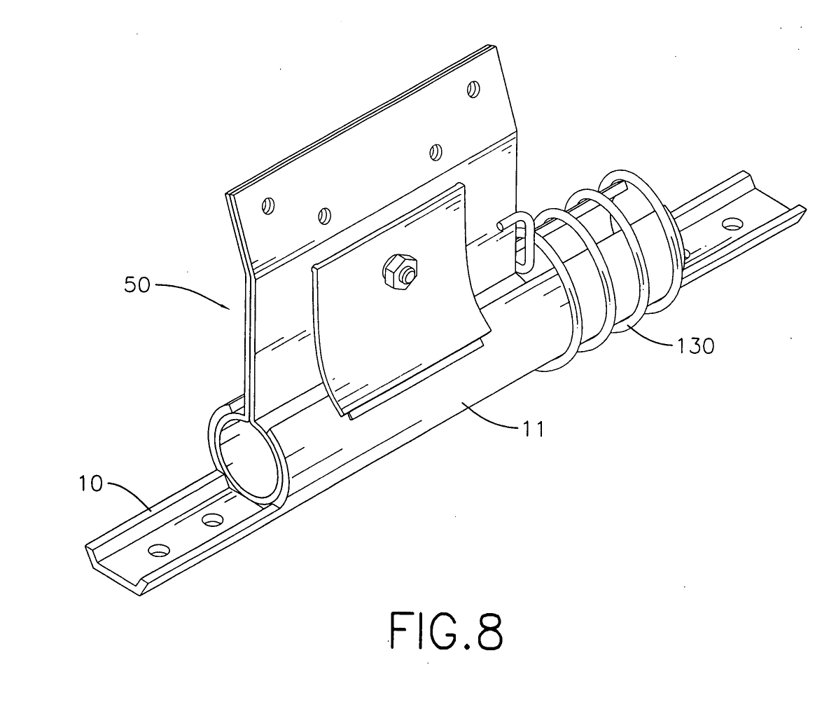

With reference to FIG. 8, a coil spring (130) is mounted around the barrel (11) of the third preferred embodiment. A first end of the coil spring (130) is mounted on the pivotal element (50) and a second end of the coil spring (130) is mounted on the barrel (11) so that a recoiling force is applied to the pivotal element (50).

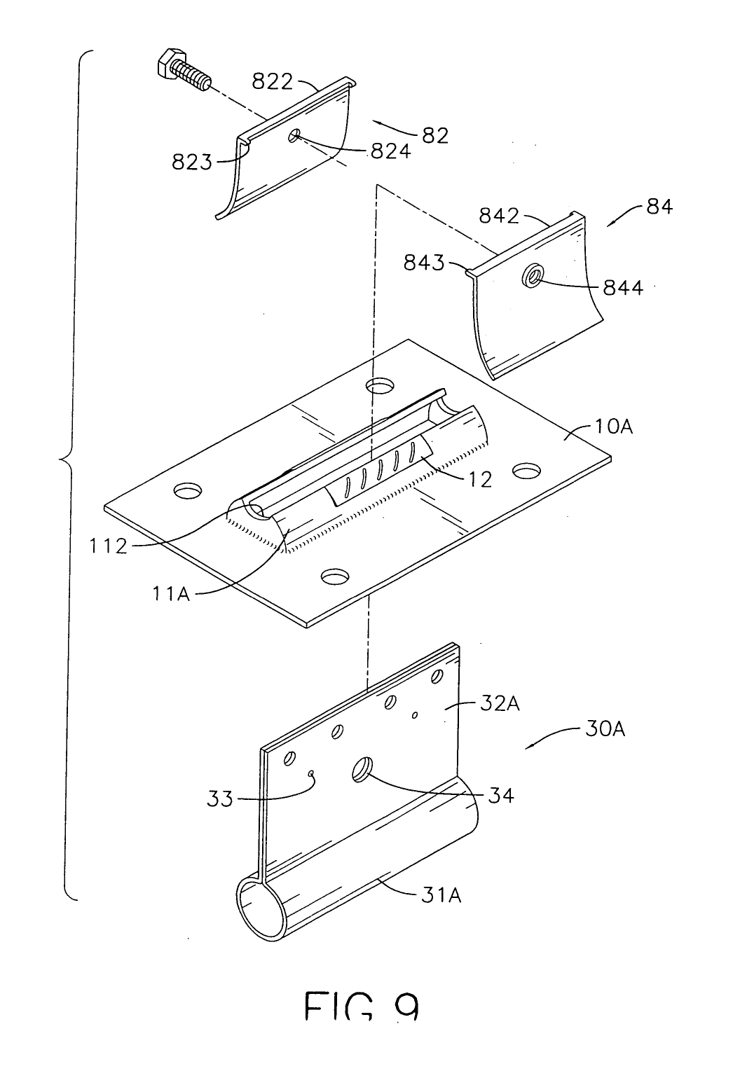

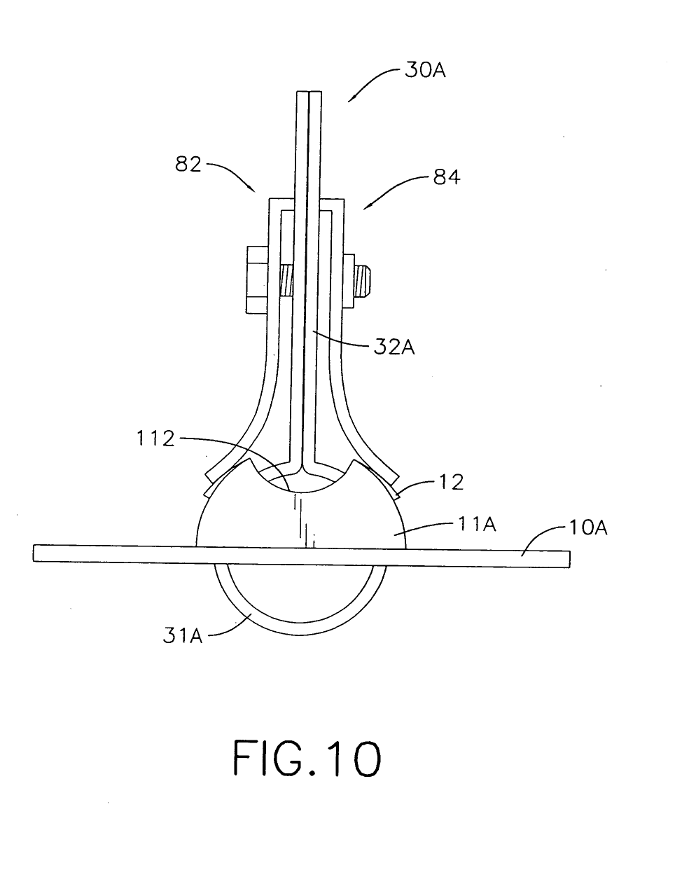

With reference to FIGS. 9 and 10, a sixth preferred embodiment of an adjusting device for a screen has a base (10A), a pivotal element (30A) and two elastic elements (82,84).

The base (10A) has a top, a bottom, a barrel (11A) formed in a middle portion of the top, and an opening (112) defined through the barrel (11A) and the base (10A). The barrel (11A) has a frictional device mounted on the barrel (11A). In a preferred embodiment, the frictional device is two flanges (12) respectively formed on two sides of the opening (112). Each flange (12) has at least one groove defined therein for oil storage.

The pivotal element (30A) has a hollow shaft (31A) and a flat (32A) axially extending out from the shaft (31A). Multiple holes (33) are respectively defined in two sides of the flat (32A) and a securing hole (34) is defined through the flat (32A). The shaft (31A) is held inside the barrel (11A) and the flat (32A) extends from the opening (112) from the bottom of the base (10A).

Two elastic elements (82,84) are respectively mounted two sides of the flat (32A) with a fastener. Each elastic element (82,84) has a top flange (822,842) formed on and laterally extending from a top of the elastic element (82,84) and abutting with the flat (32A). Two lugs (823,843) are formed respectively at two ends of each top flange (822,842) and are engaged respectively with the holes (33) in the flat (32A). Each elastic element (82,84) has a bottom abutting against one of the flanges (12) on the barrel (11A). To attach the elastic elements (82,84) onto the flat (32A), a securing hole (824) and a threaded hole (844) are defined respectively in the elastic elements (82,84). The fastener extends through the securing holes (824,34) in the elastic element (82) and the flat (32A) and is screwed into the threaded hole (844) in the elastic element (84), the elastic elements (82,84) are attached to the flat (32A) with the fastener.

In usage, the elastic elements (82,84) respectively contact with the flanges (12), and the friction force between the flanges (12) and the elastic elements (82,84) can be changed by means of loosening or tightening the fastener.

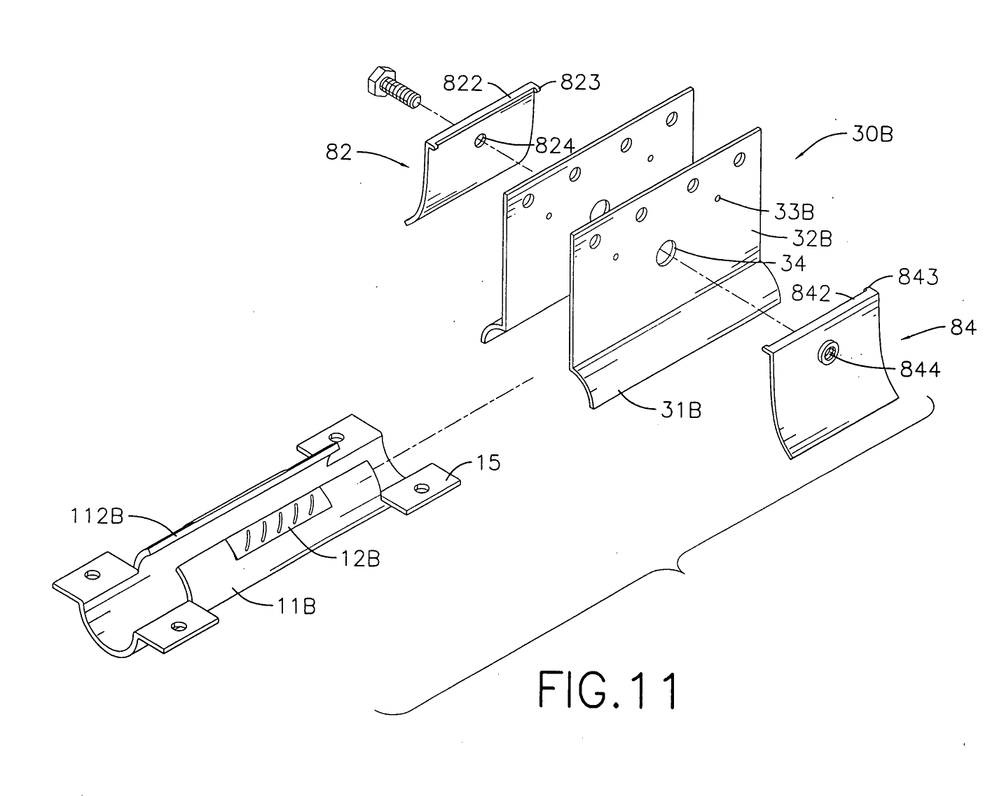

With reference to FIG. 11, a seventh preferred embodiment of an adjusting device for a screen has a barrel (11B), a pivotal element (30B) and two elastic elements (82,84).

The barrel (11B) is hollow and has an opening (112B) longitudinally defined in the barrel (11B). The barrel (11B) has a frictional device mounted on the barrel (11B). In a preferred embodiment, the frictional device is two flanges (12B) respectively formed on two sides of the opening (112B). Each flange (12B) has at least one groove defined therein for oil storage. The barrel (11B) further has multiple connecting tabs (15) formed on and extending laterally from two ends of the barrel (11B) to connect with a base of a screen.

The pivotal element (30B) comprises a hollow shaft and a flat. The hollow shaft is composed of two curved tabs (31B). The curved tabs (31B) are held inside the barrel (11B). The flat comprises two plates (32B) axially and respectively extending out from the curved tabs (31B). The plates (32B) abut with each other to form as a flat and extend from the opening (112B). Multiple holes (33B) are respectively defined in the plates (32B), and a securing hole (34) is defined through each plate (32B) and aligns with each other.

Two elastic elements (82,84) are respectively attached to the plates (32B) with a fastener. Each elastic element (82,84) has a top flange (822,842) formed on and laterally extending from a top of the elastic element (82,84) and abutting with a corresponding plate (32B). Two lugs (823,843) are formed respectively at two ends of each top flange (822,842) and are engaged respectively with the holes (33B) in the corresponding plate (32B). Each elastic element (82,84) has a bottom abutting against one of the flanges (12B) on the barrel (11B). To attach the elastic elements (82,84) onto the plates (32B), a securing hole (824) and a threaded hole (844) are defined respectively in the elastic elements (82,84). The fastener extends through the securing holes (824,34) in the elastic element (82) and the plates (32A) and is screwed into the threaded hole (844) in the elastic element (84), the elastic elements (82,84) are attached to the plates (32B) with the fastener.

Hence, the present invention with a simple structure can be assembled quickly with a lowered cost.

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

What is claimed is:

1. An adjusting device for a screen comprising:
a hollow barrel having
a frictional device mounted on the barrel, and
an opening longitudinally defined in the barrel;
a pivotal device mounted in the hollow barrel and having
a hollow shaft rotatably mounted in the hollow barrel and a flat axially extending out from the shaft and the opening in the barrel; and
at least one elastic element mounted on the pivotal device and contacting with the frictional device on the at least one fin for holding the shaft in position relative to the barrel.

2. The adjusting device for a screen as claimed in claim 1, wherein the frictional device comprises at least one flange defined on the barrel near the opening.

3. The adjusting device for a screen as claimed in claim 1, wherein a hollow outer cylinder is mounted between the barrel and the shaft and has a first gap longitudinally defined in the outer cylinder and through which the flat on the shaft extends.

4. The adjusting device for a screen as claimed in claim 3, wherein the at least one elastic element extends out from the hollow outer cylinder.

5. The adjusting device for a screen as claimed in claim 1, wherein a hollow inner cylinder is mounted between the barrel and the outer cylinder.

6. The adjusting device for a screen as claimed in claim 1, wherein the at least one elastic element is fastened on the flat.

7. The adjusting device for a screen as claimed in claim 6, wherein the at least one elastic element is fastened on the flat with a fastener.

8. The adjusting device for a screen as claimed in claim 1, wherein the at least one elastic element is integrally formed on the flat.

9. The adjusting device for a screen as claimed in claim 8, wherein the at least one elastic element is fastened on the flat with a fastener.

10. The adjusting device for a screen as claimed in claim 1, wherein a slot is lateral defined in the flat and parallel to the shaft; and
the frictional device is a fin inserted into the slot, securely connected to the barrel, mounted over the opening in the barrel and contacting with the at least one elastic element on the flat.

11. The adjusting device for a screen as claimed in claim 1, wherein a post is inserted into the shaft.

12. The adjusting device for a screen as claimed in claim 1, wherein a coil spring is mounted around the barrel and a first end of the coil spring is mounted on the pivotal element and a second end of the coil spring is mounted on the barrel.

13. The adjusting device for a screen as claimed in claim 1 further comprising a base on which the barrel is mounted.

14. The adjusting device for a screen as claimed in claim 13, wherein
the base has a top and a bottom;
the barrel formed in a middle portion of the top;
the opening is defined through the barrel and the base;
the shaft is held inside the barrel and the flat extends from the opening from the bottom of the base; and
two elastic elements are respectively mounted two sides of the flat with a fastener.

15. The adjusting device for a screen as claimed in claim 14, wherein the frictional device comprises two flanges defined on the barrel at two sides of the opening and abutting respectively with the elastic elements.

16. The adjusting device for a screen as claimed in claim 12, wherein the at least one elastic element is fastened on the flat with a fastener.

17. The adjusting device for a screen as claimed in claim 1, wherein
the frictional device is two flanges respectively formed on two sides of the opening;
the barrel further has multiple connecting tabs formed on and extending laterally from two ends of the barrel;
the hollow shaft is composed of two curved tabs held inside the barrel;
the flat comprises two plates axially and respectively extending out from the curved tabs, abutting with each other to form as the flat and extending from the opening; and
two elastic elements are respectively mounted two sides of the flat with a fastener.

18. The adjusting device for a screen as claimed in claim 1, wherein
the pivotal device has two elastic elements; and
the frictional device comprises two flanges respectively formed on two sides of the opening and abutting respectively with the elastic elements.

19. The adjusting device for a screen as claimed in claim 1, wherein the frictional device comprises at least one flange defined on the barrel near the opening; and
each one of the at least one flange has at least one groove defined in the flange for oil storage.
